(19) United States
(12) Patent Application Publication
(10) Pub. No.: US 2013/0240247 A1
(43) Pub. Date: Sep. 19, 2013

(54) Apparatus and method for a conductive elastomer on a coaxial cable or a microcable to improve signal integrity probing

(71) Applicants: Thomas P. Warwick, Melbourne, FL (US); James V. Russell, New Hope, PA (US)

(72) Inventors: Thomas P. Warwick, Melbourne, FL (US); James V. Russell, New Hope, PA (US)

(73) Assignee: R & D Circuits, Inc., South Plainfield, NJ (US)

(21) Appl. No.: 13/385,914

(22) Filed: Mar. 14, 2012

(51) Int. Cl. H02G 1/00; B23P 17/04

(52) U.S. Cl. 174/135; 29/464

(57) ABSTRACT

A method and structure for improving signal integrity probing. A coaxial or a microcoaxial cable is threaded through an optional alignment substrate where the cable is used to support or align the cable or an array of cables. A conductive elastomer is placed on a cable or a microcoaxial cable to improve signal integrity probing.

### BACKGROUND

1. Field

The present disclosure relates to an apparatus and a method for improving signal integrity probing. In particular, the present disclosure provides for improving signal integrity probing by providing a conductive elastomer on a cable or a microcoaxial cable.

2. The Related Art

Signal integrity probing requires good electrical connections. However there are problems that prevent good electrical connections from being formed with the contact surface to be probed. The contact surface that is the subject of the probing may typically have oxides, oils or debris formed on its surface. Such deposits will make it difficult if not impossible to effect a good probing contact and thus impair a good electrical connection. It would be desirable to effect good electrical connections for improved signal integrity probing.

### SUMMARY

It would be desirable to provide a method and structure for improving signal integrity that avoids the drawbacks of the aforementioned problems. This is accomplished by providing a method and structure for improving signal integrity probing by threading a coaxial or microcoaxial cable, having a conductive elastomer, thereon through an optional alignment substrate where the cable is used to support or align the cable or an array of cables.

### BRIEF DESCRIPTION OF THE DRAWINGS

FIG. 1 is a sectional view of a first embodiment of the present disclosure in which a coaxial or micro coaxial cable extends through an alignment substrate (which can be either a conductive or non-conductive substrate) and conductive elastomers are provided to the center conductor region in a column near where the where the shield of the cable and the top surface of the substrate meet; and

FIG. 2 is a sectional view of a second embodiment of the present disclosure in which a coaxial or micro coaxial cable extends through an alignment substrate (which can be either a conductive or non-conductive substrate) and conductive elastomers are provided to the center conductor region in a column near where the where the shield of the cable and the top surface of the substrate meet and also applied to the bottom side of the substrate.

### DETAILED DESCRIPTION OF THE PREFERRED EMBODIMENT(S)

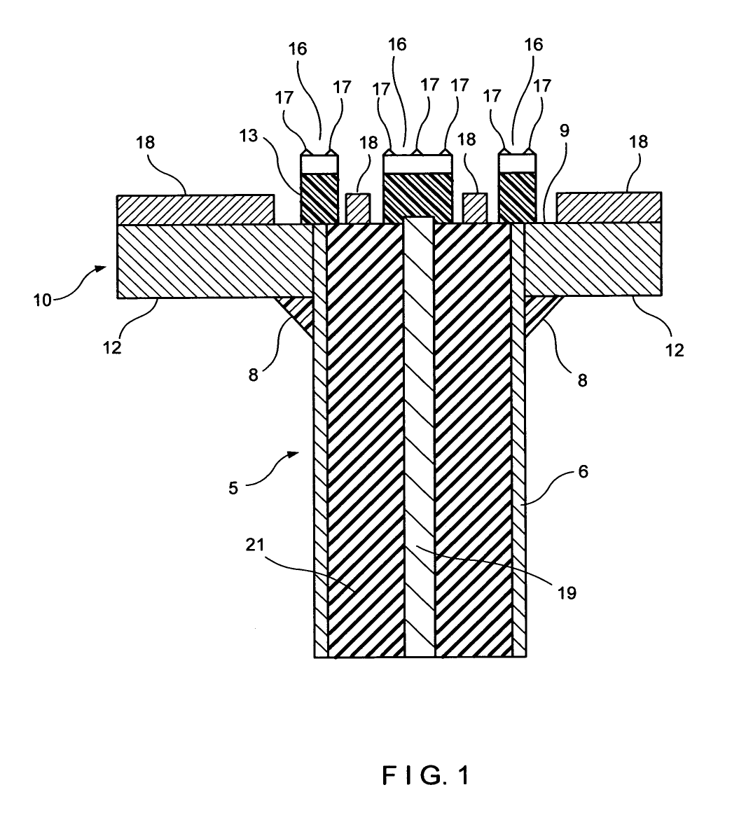

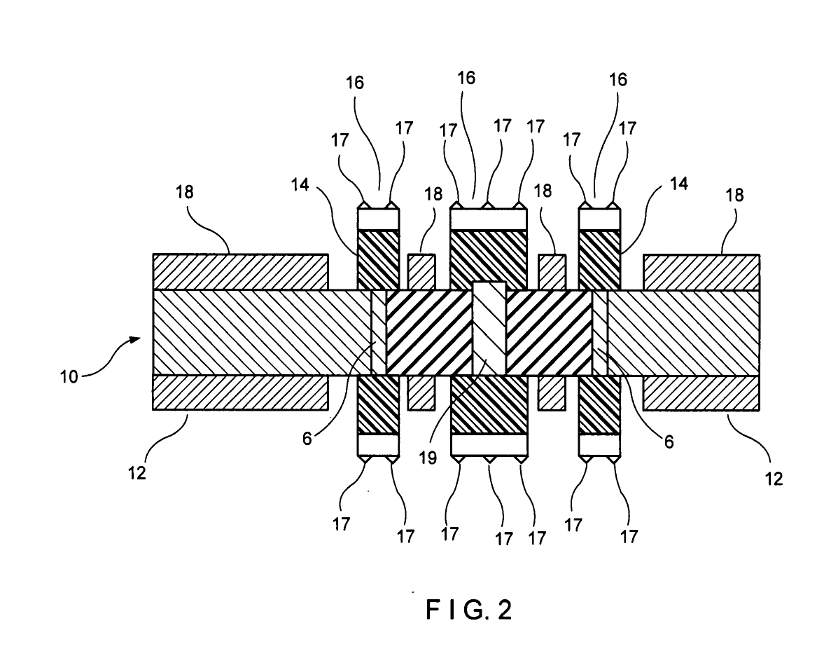

Referring now to FIGS. 1 and 2 of the drawings, FIG. 1 shows a first embodiment of the present disclosure. In this embodiment a coaxial cable or a microcable 5 is threaded through an optional alignment substrate 10. This substrate 10 supports and aligns the cable or an array of cables 5. The substrate 10 is preferably formed as either an electrically conductive metal or as an insulator. The cable 5 has an outer metallic shell 6. The metallic shell 6 remains in intimate contact with the substrate 10 and is preferably soldered 8 to provide good electrical connection.

The cable 5 has a top side 8 that is preferably flush with the top side 9 of the substrate 10. The cable 5 has a bottom side 11 that is preferably flush with a bottom side 12 of the substrate 10 or extends outward from the bottom side 12 of the substrate 10 (as shown in FIG. 1) and is free to accept a traditional connector or can be attached to an electronic assembly through any conventional techniques known in the art.

As seen in FIG. 1, a conductive elastomer 13 is applied to the center conductor region 19 (insulated from outer coaxial cables by coaxial dielectic 21) in a column 14. This conductive elastomer 13 is preferably applied in the ground shielding region 15 where the shield of the cable 5 and the top surface 9 of the substrate 10 meet. These conductive elastomeric regions are preferably isolated from each other in order to prevent electrical shorting (as shown in FIGS. 1 and 2). Optionally a nonconductive substrate can be applied in the open areas on top 9 of the substrate 10 around the conductive elastomers 13 close enough to provide room for the elastomer 13 to expand when it is compressed (as seen in FIG. 1 with compression stops 18) but will prevent it from over compression and damage. In FIG. 1 a low contact resistance metal can be employed to form a pad 16 having sharp points or “aspirates” 17 that are formed on top 9 of the substrate 10 to help penetrate oxides, oils of debris that may form on the subject contact point that is intended to be probed.

As in FIG. 1, FIG. 2 illustrates a method and apparatus in which a low contact resistance metal can be employed to form a pad 16 having sharp points or “aspirates” 17 that are formed on top 9 of the substrate 10 to help penetrate oxides, oils or debris that may form on the subject contact point that is intended to be probed. In addition in the embodiment of FIG. 2 this same structure and method for the top side 9 of the substrate 10 can also be used for the bottom side 12 of the substrate 10 to provide for a high speed, high band width connector.

While presently preferred embodiments have been described for the purposes of the disclosure, it is understood that numerous changes in the arrangement of apparatus parts can be made by those skilled in the art. Such changes are encompassed within the spirit of the invention as defined by the appended claims.

1. A method for improving signal integrity probing, the steps comprising:
threading a coaxial or a microcoaxial cable through an optional alignment substrate wherein said substrate supports or aligns the cable or an array of cables; and
placing a conductive elastomer on said cable or said microcoaxial cable to improve signal integrity probing.

2. The method for improving signal integrity probing according to claim 1 further comprising forming a pad with a low contact resistance metal, said pad having sharp points or “aspirates” formed on top to help penetrate oxides, oils of debris that may form on the subject contact point that is intended to be probed.

3. The method according to claim 2 further comprising forming another pad with a low contact resistance metal having sharp points or “aspirates” formed on a bottom side of said substrate to provide for a high speed, high band width connector.

4. An apparatus for improving signal integrity probing, comprising:
a coaxial or a microcoaxial cable threaded through an optional alignment substrate wherein said substrate supports or aligns the cable or an array of cables; and a conductive elastomer placed on said cable or said microcoaxial cable to improve signal integrity probing.

5. The apparatus for improving signal integrity probing according to claim 4 wherein said conductive elastomer is placed near a top surface of said substrate.

6. The apparatus for improving signal integrity probing according to claim 4 wherein said conductive elastomer is applied to the center conductor region in a column.

7. The apparatus for improving signal integrity probing according to claim 6 said conductive elastomer is applied in the ground shielding region where the shield of the cable and the top surface of the substrate meet.

8. The apparatus for improving signal integrity probing according to claim 4 wherein said substrate is formed as an electrically conductive metal.

9. The apparatus for improving signal integrity probing according to claim 4 wherein said substrate is formed as an insulator.

10. The apparatus for improving signal integrity probing according to claim 4 wherein said cable has an outer metallic shell that is placed firmly in intimate contact with said substrate to ensure good electrical connection.

11. The apparatus for improving signal integrity probing according to claim 7 wherein said outer metallic shell is soldered to said substrate to ensure good electrical connection.

12. The apparatus for improving signal integrity probing according to claim 4 wherein said cable has a top side that is flush with a top of said substrate.

13. The apparatus for improving signal integrity probing according to claim 4 wherein said cable has a bottom side of the cable that is flush to the bottom and is free to either accept a traditional connector or to be attached to an electronic assembly through any conventional techniques known in the art.

14. The apparatus for improving signal integrity probing according to claim 4 wherein said cable has a bottom that extends outward from the bottom and can be free to either accept a traditional connector or be attached to an electronic assembly through any conventional techniques known in the art.

15. The apparatus for improving signal integrity probing according to claim 4 further comprising low contact resistance metal forms a pad with sharp points or “aspirates” formed on top to help penetrate oxides, oils of debris that may form on the subject contact point that is intended to be probed.

16. The apparatus for improving signal integrity probing according to claim 15 wherein a low contact resistance metal forms another pad with sharp points or “aspirates” formed on a bottom side of said substrate to provide for a high speed, high band width connector.
